(19) United States
(12) Patent Application Publication
(10) Pub. No.: US 2025/0148070 A1
(43) Pub. Date: May 8, 2025

(54) SYSTEM FOR ESTABLISHING A COMMUNICATION CONNECTION BETWEEN A FIRST DEVICE AND A SERVER VIA A NETWORK AND METHOD FOR AUTHORIZING A CONFIGURATION OF A FIRST DEVICE BY A SECOND DEVICE

(71) Applicant: WAGO Verwaltungsgesellschaft mbH, Minden (DE)

(72) Inventors: Dirk MEIHOEFER, Minden (DE); Sergei IKKERT, Minden (DE)

(73) Assignee: WAGO Verwaltungsgesellschaft mbH, Minden (DE)

(21) Appl. No.: 18/939,593

(22) Filed: Nov. 7, 2024

(30) Foreign Application Priority Data
Nov. 7, 2023 (DE) 10 2023 130 773.8

(51) Int. Cl. G06F 21/44; H04L 67/141

(52) U.S. Cl. CPC G06F 21/445; H04L 67/141

(57) ABSTRACT

Provided is a method for authorizing a configuring of a first device by a second device and a system for establishing a communication connection between a first device and a server over a network. The method comprises displaying, by the first device, an at least partially randomly generated first code, detecting, by the second device, the first code by means of an optical sensor, detecting, by the second device, a second code provided on a surface of the first device, authenticating the second device to a server, authenticating, by the server, an identity of the second device, sending, by the first device, a first representation of the codes to the server over a network, sending, by the second device, a second representation of the codes to the server, and authorizing, by the server, a configuring of the first device by the second device based on the representations.

This nonprovisional application claims priority under 35 U.S.C. § 119 (a) to German Patent Application No. 10 2023 130 773.8, which was filed in Germany on Nov. 7, 2023, and which is herein incorporated by reference.

### BACKGROUND OF THE INVENTION

### Field of the Invention

The present invention relates to a system for establishing a communication connection between a first device and a server via a network and a method for authorizing configuring the first device by a second device.

### Description of the Background Art

The configuration of devices in security-relevant facilities may be subject to certain security precautions to prevent configuration by unauthorized persons. For example, it may be contemplated that devices which are used for the configuration must be authorized in advance. A configuration by unauthorized devices would then fail, which would indirectly prevent a configuration by unauthorized persons.

### SUMMARY OF THE INVENTION

It is therefore an objection of the invention to provide a method for displaying, by a first device, a code, detecting, by a second device, the code by means of an optical sensor, authenticating the second device to a server, authenticating, by the server, an identity of the second device, sending, by the second device, a representation of the code to the server, and authorizing, by the server, a configuring of the first device by the second device based on the representation.

In this regard, the term “device”, can be understood, in particular, as referring to an electronic device which comprises a processor, a memory (in which instructions executable by the processor are stored) and, if applicable, comprises sensors and/or actuators, is configured to be directly connected with sensors or actuators, or is configured to establish a connection with sensors and actuators. The first device may, for example, be a control device. The second device may, for example, be a portable device with an energy storage that supplies the second device with energy. The control device may be a modular fieldbus node. The control device may be a head station or an input/output module (I/O module) of a modular fieldbus node.

In this context, the term “head station”, may refer to a component of a modular fieldbus node whose task it is to make the data and/or services of the I/O modules, which are connected to the head station, available via the fieldbus to which the head station is connected. In this regard, the term “I/O module”, can be understood to refer, in particular, to an apparatus which is serially connectible or serially connected during operation to a head station and which connects one or more field devices with the head station and, if necessary (via the head station) with a higher-level control unit.

An I/O module may have one or more inputs and/or outputs for connecting field devices with the I/O module. If a field device is connected to an I/O module, it may be necessary to configure the I/O module to operate the field device. As part of the configuring, it may, for example, be specified which data is to be derived from signals received through the inputs of the I/O module and transmitted to a head station. Furthermore, it may be specified as part of the configuring which signals are to be derived from data received from the head station and output through the outputs of the I/O module. In addition, a change or update of a configuration data set stored in the I/O module may be necessary after an initial configuration if, for example, the assigned tasks and/or the environment of an I/O module changes, or a defective I/O module needs to be replaced.

If a head station is put into operation or (another) I/O module is connected to the head station, it may be necessary to configure the head station (to operate the I/O module). As part of the configuring, it may, for example, be specified how the head station can communicate with the higher-level control unit and whether (or which) data of the I/O module is to be processed by the head station or forwarded to the higher-level control unit. Furthermore, it may be specified as part of the configuring whether the data (or which data) from the higher-level control unit is to be processed by the head station or forwarded to the I/O module. In addition, a change or update of a configuration data set stored in the head station may be necessary after an initial configuration if, for example, the assigned tasks and/or the environment of a head station changes, or a defective head station needs to be replaced.

The term “configuration data set”, can be understood, in particular, as referring to a data set that specifies how process images are to be generated (e.g., how data is to be derived from signals received through the inputs of the I/O module and how said data is to be transmitted, e.g. via a bus, to the head station or from the head station to the higher-level control unit) and/or which data is to be forwarded from the higher-level control unit to the I/O module or how signals are to be derived from data transmitted from the head station to the I/O module (which are output, e.g., through the outputs of the I/O module).

There may be field devices that provide state signals or process control signals connected to the inputs and/or outputs. In this regard, the term “field devices”, can be understood, in particular, as referring to sensors and/or actuators which are connected (in terms of signaling) to the I/O module (e.g., electrically connected to the I/O module). Furthermore, the terms “input” and “output” can be understood, in particular, as referring to electric terminals such as, for example, connecting clamps.

The method may further comprise sending, by the first device, a first message over a network to the server, the first message comprising first information regarding an identity of the first device, sending, by the server, a second message over the network to the first device, and deriving, by the first device, the code from the second message.

The first device may be configured to send the first message to the server over the network as soon as the first device is connected to the network or in response to an input from an operator (commissioning engineer). The input may comprise, for example, actuating a button or switch mounted on the first device or touching a touch-sensitive display mounted on the first device.

The server may be configured to send the second message in response to the first message. For example, as described in the previous paragraph, the first device may send the first message to the server over the network as soon as the first device is connected to the network, and the server may, in response to receiving the first message, send the second message to the second device and assign the content of the second message (e.g. the code) to the first device.

The server may be configured to send the second message in response to a third message from the second device, the third message comprising second information regarding the identity of the first device. The method may further comprise detecting, by the second device, a second code by means of the optical sensor and deriving the second information regarding the identity of the first device from the second code. The second code may be provided on a surface of the first device. The second code may be a one- or two-dimensional barcode.

This allows the operator (commissioning engineer) to specifically select a device that is to be configured.

The code may be an at least partially randomly generated first code and the method may further comprise detecting, by the second device, a second code provided on a surface of the first device. Furthermore, the representation of the first code may be comprised in a second representation of the codes, and the method may further comprise sending, by the first device, a first representation of the codes to the server over a network, sending, by the second device, the second representation of the codes to the server, and authorizing, by the server, the configuration of the first device by the second device based on the representations.

The desire to configure the first device with the assistance of the second device is thus signaled to the server in that the server receives representations of the codes from both the first device and the second device and can determine by comparing the codes that the operator (commissioning engineer) wants to configure the first device and, depending on the circumstances, is also allowed to do so.

The second code may be a one- or two-dimensional barcode. The second code may describe (e.g. by specifying a manufacturer identification, a model number, etc.) and/or identify (e.g. by specifying a unique device number, e.g. a serial number, or a public key) the first device. The second code may further comprise a network address (e.g., an IP address) of the server. The combination of the first code and the second code may form a unique device key.

Displaying the first code may comprise sequentially displaying first elements of which the first code is composed. For example, the first elements may be displayed sequentially on a digital display or by activating/deactivating one or more signal lights. For example, the sequentially displaying of the first elements may be performed by flashing one or more signal lights.

The first device may be configured to start displaying the first code in response to a request by the second device or a manual input to the first device.

The first device may be configured to stop displaying the first code in response to a request by the second device or a manual input to the first device.

A system according to the invention comprises a first device and a second device, wherein the second device is configured to authenticate itself to a server and to send a representation of a code, which is visually displayed by the first device, to the server. The server may be configured to verify the representation and, depending on the verification result, authorize a configuring of the first device by the second device.

The second device may be further configured to read a one- or two-dimensional barcode and to derive information regarding the identity of the first device from the one- or two-dimensional barcode and send it to the server. The one- or two-dimensional barcode may be provided on a surface of the first device. The information comprised in the one- or two-dimensional barcode may describe (e.g., by specifying a manufacturer identification, a model number, etc.) and/or identify it (e.g., by specifying a unique device number) the first device. The one- or two-dimensional barcode may further comprise a network address (e.g., an IP address) of the server.

The second device may be configured to send the first code and a second code, which is provided on a surface of the first device and detected by the second device, to the server. The combination of the first code and the second code may form a unique device key.

The first device may be configured to generate the first code at least partially randomly and to authenticate itself to the server by sending a first representation of the first code and the second code.

Notably, all features described in connection with the system may also be features of the method and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a fieldbus system;

FIG. 2 shows a fieldbus node and fieldbus devices connected to the fieldbus node;

FIG. 3a, FIG. 3b, and FIG. 3c show a first device, a second device and a server; and

FIG. 4 shows a flowchart of a method for authorizing configuring of the first device by the second device.

### DETAILED DESCRIPTION

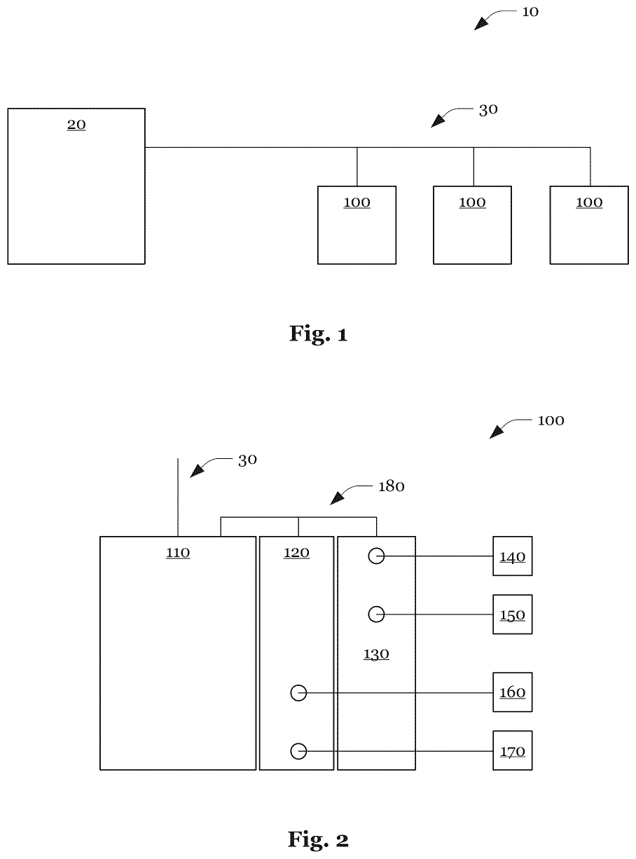

FIG. 1 shows a block diagram of a fieldbus system 10. The fieldbus system 10 comprises a higher-level control unit 20 to which a plurality of fieldbus nodes 100 are connected via a fieldbus 30. The higher-level control unit 20 may be used both for monitoring and for controlling, an installation that is controlled by the fieldbus system 10. If the higher-level control unit 20 monitors an installation, the higher-level control unit 20 may cyclically or acyclically receive state data describing the state of the installation from the fieldbus nodes 100 and generate an alarm signal if the state of the installation deviates (substantially) from a desired/permitted state or state range. If the higher-level control unit 20 (not only monitors but also) controls the installation, the higher-level control unit 20 may cyclically or acyclically receive state data from the fieldbus nodes 100 and, taking the state data into account, determine control data that is transmitted to the fieldbus nodes 100.

FIG. 2 shows an exemplary modular fieldbus node 100, comprising a head station 110 and two I/O modules 120 and 130 which are serially connected to the head station 110. FIG. 2 further shows field devices 140, 150, 160 and 170, such as sensors and actuators, which are connected to the I/O modules 120 and 130. During operation, the I/O modules 120 and 130 read sensor signals through the inputs and generate state data from the sensor signals, which are transmitted to the head station 110 via the local bus 180. The head station 110 may process the state data locally and/or forward it (potentially in modified form) to the higher-level control unit 20. The higher-level control unit 20 (or head station 110 in the case of local processing) may then generate, taking the state data into account, control data.

The control data generated by the higher-level control unit 20 may then be transmitted to the (same or another) head station 110 via the field bus 30. The control data transmitted to the head station 110 (or generated by head station 110) are then forwarded/transmitted (potentially in modified form) to the I/O modules 120 and 130. The I/O modules 120 and 130 receive the control data and output control signals corresponding to the control data at the outputs to which the actuators are connected. The communication of data between the components of the fieldbus system 10 and the mapping of the sensor signals to state data and the mapping of the control data to control signals may be adapted to different application scenarios by configuring fieldbus nodes 100.

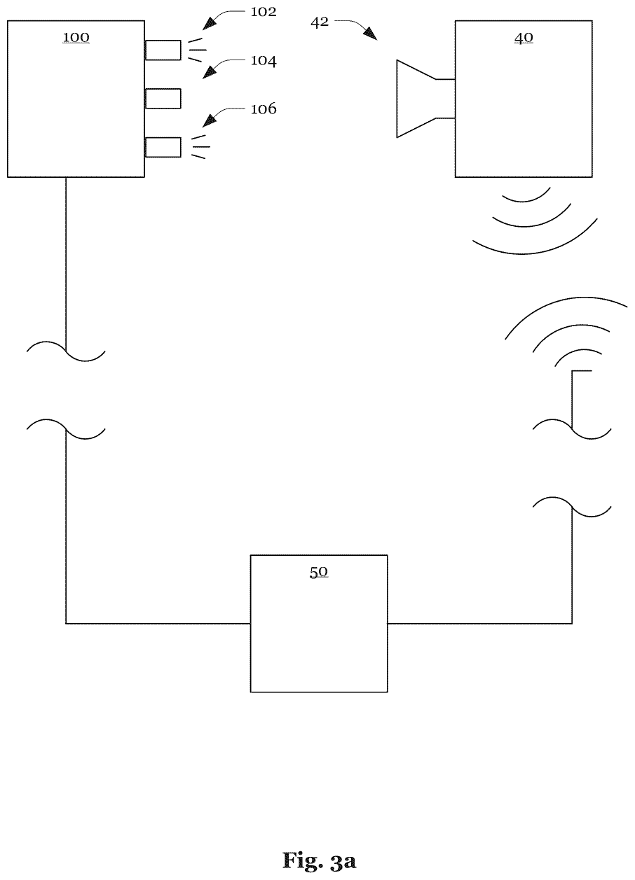

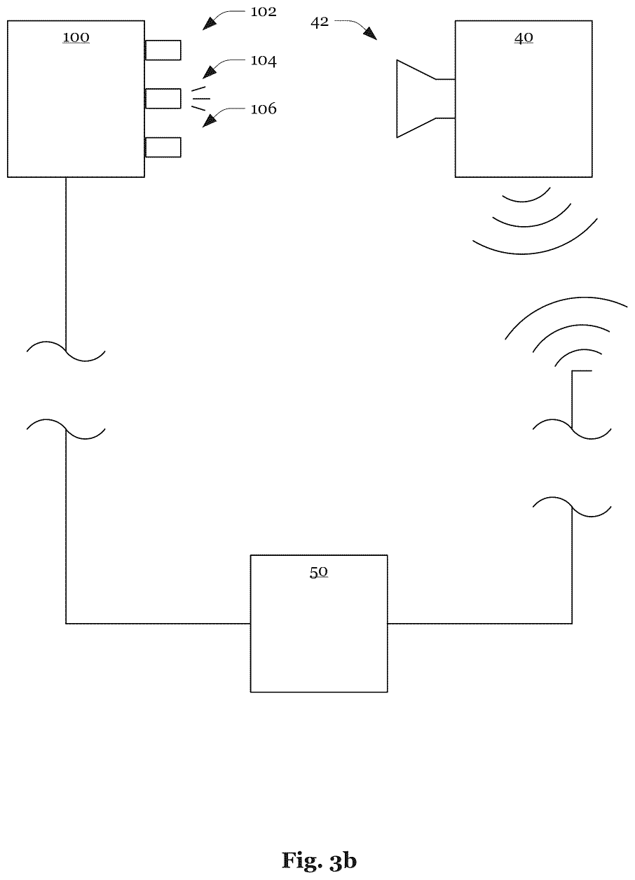

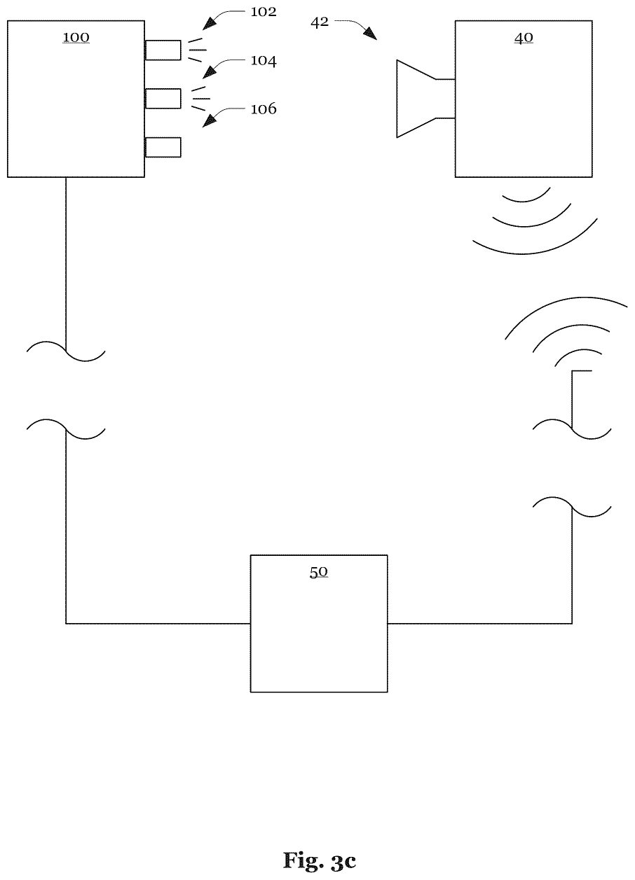

FIG. 3a shows a fieldbus node 100 and a computer 40 which is configured to initiate the configuring of the fieldbus node 100, i.e., the head station 110 and/or the I/O modules 120 and 130 of the fieldbus node 100. The computer 40 may comprise a display device on which a graphical interface of a configuration program may be shown. The graphical interface may allow graphically displaying the desired topology of the fieldbus node 100 and assigning the parameters required for configuration of the head station 110 and/or the I/O modules 120 and 130 (and in particular their inputs and/or outputs) or retrieving an assignment created on another computer and stored on the computer 40. A configuration data set for the head station 110 and each of the I/O modules 120 and 130 (or for all of them together) may then be formed from the parameters and transferred to and stored in the head station 110 and the I/O modules 120 and 130 of the fieldbus node 100 in order to configure them.

However, in order to protect the head station 110 and the I/O modules 120 and 130 of the fieldbus node 100 from being configured by unauthorized persons, they are configured to only accept a configuration data set from a remotely located server 50 or to only apply a configuration data set if the server 50 has preauthorized the application. In order to obtain the necessary cooperation of the server 50, the computer 40 has to prove to the server 50 that it is located in the immediate vicinity of the fieldbus node 100 and thus has direct physical access to the fieldbus node 100. This proof is provided by the fieldbus node 100 displaying a code which the computer 40 detects by means of an optical sensor 42 and sends to the server 50.

As illustrated in FIG. 3a, FIG. 3b, and FIG. 3b, the fieldbus node 100 (e.g., the head station 110 or one of the I/O modules 120 and 130) can be provided with several lights 102, 104, and 106, which output the code sequentially. For example, the code may include a series of elements, each element being a 3-bit value that may be displayed by lights 102, 104, and 106. The code may be generated at least partially randomly by the fieldbus node 100 and sent to the server 50 via a (possibly encrypted) network connection. Alternatively, the code may be received from the server 50 via a (possibly encrypted) network connection. For example, the fieldbus node 100 may be configured to log on to the server 50 (e.g., using an identification and password) and request the code upon booting or in response to a manual input or signal. It is also conceivable that the code is stored persistently on the fieldbus node 100 and deposited on the server 50 or can be reconstructed or retrieved by the server 50.

It is also conceivable that the sending of the code from the server 50 to the fieldbus node 100 is triggered by the computer 40. For example, the computer 40 may be configured to send a message over the network to the server 50, wherein the message comprises information regarding the identity of the fieldbus node 100. The identity of the fieldbus node 100 may be stored on the computer 40, entered by the user of the computer 40, or detected using the optical sensor 42. For example, the fieldbus node 100 may be provided with a code that may be detected by the optical sensor 42. For example, a one- or two-dimensional barcode containing information identifying the fieldbus node 100 may be applied or glued to the housing of the fieldbus node 100. The one- or two-dimensional barcode may also include a link to a program that evaluates the code displayed using the lights 102, 104 and 106 and sends it to the server 50 and/or a network address of the server 50.

Furthermore, it may be envisaged that not only the computer 40 is configured to send a message which includes information regarding the identity of the fieldbus node 100 via the network to the server 50 but also the fieldbus node 100. The information regarding the identity of the fieldbus node 100 may then be used by the server 50 to assign the messages of the computer 40 and the fieldbus node 100 to each other and to check the optically displayed codes for a match. In this case, the server 50 does not have to maintain any information regarding the identity of the fieldbus node 100 or the association of the identity of the fieldbus node 100 and the code visually displayed by the fieldbus node 100.

The computer 40 may also log on to the server 50 (e.g. using an identification and a password) via a (possibly encrypted) network connection before sending the detected code. For example, the entity that owns the fieldbus node 100 may be assigned a user account on the server 50. The fieldbus node 100 may be assigned to the user account. The computer 40 may, for example, be a mobile phone, a tablet, a laptop, a smart watch or smart glasses that is connected to a local network via a wireless connection and which may establish a connection with the server 50 through a router of the local network.

Alternatively, the computer 40 may, for example, be a mobile phone, a tablet, a laptop, a smart watch or smart glasses that is connected to a mobile network via a wireless connection and which may establish a connection with the server 50 through a router of the mobile network. Furthermore, a program provided with the network address of the server 50 may run on the mobile phone, tablet, laptop, smart watch or smart glasses, whereby the user of the mobile phone, tablet, laptop, smart watch or smart glasses can navigate to the login page of the server 50 by starting the program or entering the network address.

After logging on to the server 50, the code may be sent by the computer 40 to the server 50. The server 50 may verify the code and, if the verification is successful, authorize the configuring of the fieldbus node 100 by the computer 40. This may come about by, for example, the server 50 forwarding the configuration data set from the computer 40 to the fieldbus node 100, signaling the fieldbus node 100 to accept a configuration data set received from the computer 40, or putting the fieldbus node 100 into a state in which it is ready to receive and accept a configuration data set from the computer 40.

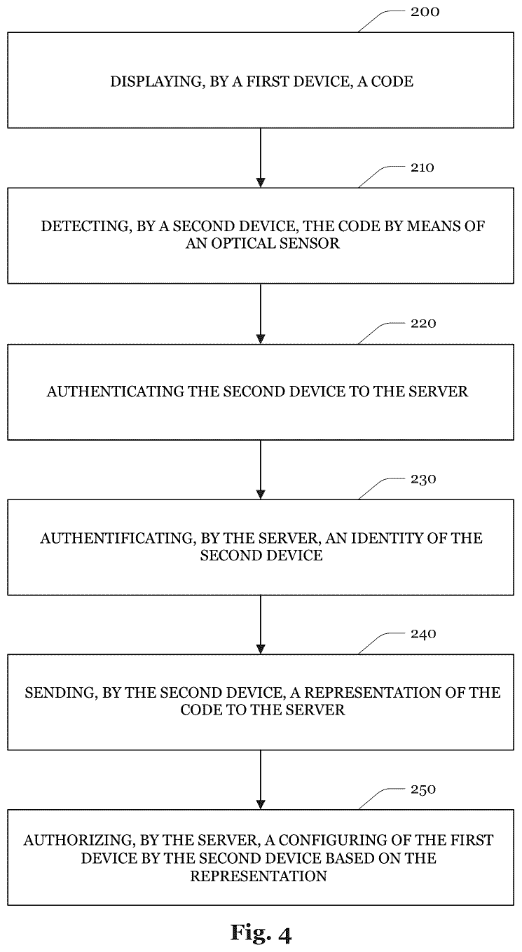

FIG. 4 shows a flow chart of a method for authorizing the configuration of a first device, e.g., the fieldbus node 100, by a second device, e.g., the computer 40. The method begins with a step 200 of displaying a code by the first device. Step 200 may, for example, be carried out by the fieldbus node 100 by sequentially outputting the code using the lights 102, 104, and 106. The method continues with a step 210 of detecting, by the second device, the code by means of an optical sensor. Step 200 may, for example, be carried out by the computer 40 by recording and evaluating the light sequence by means of a camera installed in the computer 40 or connected to the computer 40. Once the code has been detected by the computer 40, this can be indicated to the first device by a confirmation signal or a manual input on the first device (e.g. by means of a button, dip switch or a touch-sensitive display), which then stops displaying the code.

In steps 220 and 230, the second device logs on to the server 50, and in step 240, the now logged on second device sends the code to the server 50. Steps 220, 230, and 240 may be performed, for example, by the computer 40 by navigating to a login page, entering login data, and uploading the code, or by starting a specific application on the computer 40 that is configured to perform the steps. If the verification of the code by the server 50 shows that the code is correct, the server 50 authorizes the configuring of the first device by the second device.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for authorizing a configuring of a first device by a second device, the method comprising:
displaying, by the first device, an at least partially randomly generated first code;
detecting, by the second device, the first code via an optical sensor;
detecting, by the second device, a second code provided on a surface of the first device;
authenticating the second device to a server;
authenticating, by the server, an identity of the second device;
sending, by the first device, a first representation of the codes over a network to the server;
sending, by the second device, a second representation of the codes to the server; and
authorizing, by the server, a configuring of the first device by the second device based on the representations.

2. The method according to claim 1, wherein the second code is a one- or two-dimensional barcode.

3. The method according to claim 1, wherein the displaying of the first code is a sequential displaying of first elements of which the first code is composed.

4. The method according to claim 3, wherein the sequential displaying of the first elements is performed by flashing one or more signal lights.

5. The method according to claim 1, wherein the first device is configured to start displaying the first code in response to a request by the second device or a manual input to the first device.

6. The method according to claim 1, wherein the first device is configured to stop displaying the first code in response to a request by the second device or a manual input to the first device.

7. The method according to claim 1, wherein the first device is a control device.

8. The method according to claim 1, wherein the second device is a portable device with an energy storage that supplies the second device with energy.

9. A system for establishing a communication connection between a first device and a server over a network, the system comprising:
the first device; and
a second device configured to authenticate itself to the server and configured to forward a second representation of a first code, which is visually displayed by the first device, and a second code, which is provided on a surface of the first device and detected by the second device, to the server.

10. A system for establishing a communication connection between a first device and a server over a system according to claim 9, wherein the first device is configured:
to generate the first code at least partially randomly; and
to authenticate itself to the server by sending a first representation of the first code and the second code.
